(19) United States
(12) Patent Application Publication
(10) Pub. No.: US 2023/0048128 A1
(43) Pub. Date: Feb. 16, 2023

(54) MULTIPURPOSE ORGANIC ACTIVE BASED ON SOYBEAN OIL AND CAFFEINE

(71) Applicant: ARAUSUL ASSESSORIA E ENGENHARIA LTDA - ME, Videira (BR)

(72) Inventor: Tony Thomas Sartori, Videira (BR)

(73) Assignee: ARAUSUL ASSESSORIA E ENGENHARIA LTDA - ME, Videira (BR)

(21) Appl. No.: 17/798,555

(22) PCT Filed: Feb. 5, 2021
(86) PCT No.: PCT/BR2021/050055

§ 371 Date: Aug. 9, 2022

(30) Foreign Application Priority Data
Feb. 10, 2020 (BR) BR 102020002751-4

(51) Int. Cl. A01N 65/20; A01N 43/90

(52) U.S. Cl. CPC A01N 65/20; A01N 43/90

(57) ABSTRACT

The present invention relates to a soya bean oil- and caffeine-based chemical product for use as an agrochemical for agriculture, animal husbandry and agricultural systems (pesticide/insecticide/larvicide/anti-parasitic agent), having a simple formula and production process and containing widely known organic plant ingredients.

The present invention relates to a chemical product based on soybean oil and caffeine to be used as an Agricultural Defensive (pesticide/insecticide/larvicide/antiparasitic). Its Formula and Production Process are simple and it has ingredients of global knowledge.”

Currently pesticides, insecticides, larvicides and antiparasitics are indispensable in field production, due to losses generated by pests, insects, among others. Specifically in the prevention of pest action, it is increasingly common to search for so-called ecological or organic pesticides, especially in family production of fruits, vegetables, flowers, cattle, horses, birds and other animals that serve as a protein base for human consumption. Currently, it is common to use insect repellents obtained from: garlic, tobacco (nicotine), tomato leaves, pepper, among others.

The state of the art presents some documents that refer to the insecticide with ecological appeal, such as PI 9501628-7B1 (Atoxic Chemical Composition to Eliminate Insects and Other Pests), deposited on Apr. 27, 1995. This refers to a non-toxic chemical composition for use in combating various pests without causing harm to human and animal health.

In order to obtain a technological product through natural components, the present formulation was developed, which uses soybean oil and caffeine to obtain the function as an efficient pesticide, insecticide, larvicide and antiparasitic.

The action of this product is due to the combination of fatty acids and alkaloids extracted from soybean oil and the active coffee bean, caffeine, which in synergy reach the nervous system of insects causing the disruption of the impulse, also paralyzing their metabolism, causing the insects to die. The insecticidal action is given by the combination of soybean oil and caffeine.

The active to be used can be obtained in a specific tank, under agitation of 100 RPM, adding soybean oil (4.5 to 9.3%) and allowing it to heat from 100° C. to 180° C. (part A), then in a container heat water until boiling and dissolve the caffeine (0.560 to 3.12%) (part B). Then add part B to part A, allowing to stir for 1 to 1.5 hours at a temperature of 100° C. to 180° C. After stirring it is necessary to let it cool until it reaches room temperature; this process will allow the activation of fatty acids and alkaloids, as follows: from 1.0 to 3.0% cis-octadecene-9-oic acid; 4.2 to 7.0% cis,cisoctadecadiene-9,12oic acid; 0.5 to 1.7% 9-12-octadecadienoic acid; 0.7 to 2.2% hexadecanoic acid; 0.1 to 1.0% octadecanoic acid and 0.00132 to 0.00715% 3,7-dihydro-1,3,7-trimethyl-1H-purine-2,6dione.

1. A multipurpose organic active based on soybean oil and caffeine, characterized by the action from the combination of fatty acids and alkaloids extracted from soybean oil and the active coffee bean, caffeine, which synergistically affect the nervous system of insects causing the disruption of the impulse, also paralyzing their metabolism, leading the insects to death. The insecticidal action is given by the combination of soybean oil and caffeine.

2. A multipurpose organic active based on soybean oil and caffeine according to claim 1, it is characterized by the fact that:
(a) it is obtained in a tank under agitation at 100 RPM, adding soybean oil (4.5 to 9.3%) letting it heat from 100° C. to 180° C.,
(b) then in a container heat water until boiling and dissolve the caffeine (0.560 to 3.12%),
(c) then add (a) and (b), allowing to stir for 1 to 1.5 hours at a temperature of 100° C. to 180° C., after stirring it is necessary to let it cool until reaching room temperature;
wherein this process will allow the activation of fatty acids and alkaloids, as follows: from 1.0 to 3.0% cis-octadecene-9-oic acid; 4.2 to 7.0% cis,cisoctadecadiene-9,12oic acid; 0.5 to 1.7% 9-12-octadecadienoic acid; 0.7 to 2.2% hexadecanoic acid; 0.1 to 1.0% octadecanoic acid and 0.00132 to 0.00715% 3,7-dihydro-1,3,7-trimethyl-1H-purine-2,6-dione.
